(19) United States
(12) Patent Application Publication
(10) Pub. No.: US 2011/0199020 A1
(43) Pub. Date: Aug. 18, 2011

(54) METHODS OF COMMISSIONING LIGHTING SYSTEMS

(75) Inventors: Robert Henig, Palo Alto, CA (US); David Fowler, Union City, CA (US); Deepak Nulu, Milpitas, CA (US); David Leonard, Danville, CA (US)

(73) Assignee: REDWOOD SYSTEMS, INC., Fremont, CA (US)

(21) Appl. No.: 12/708,460

(22) Filed: Feb. 18, 2010

(51) Int. Cl. H05B 37/02; H05B 39/00

(52) U.S. Cl. 315/294; 315/312; 315/360

(57) ABSTRACT

A method of commissioning a lighting system is disclosed. A user is provided with a pointing device capable of emitting or returning a signal which can be received by detectors co-located with each fixture in the lighting system. The user can add a fixture to a group by aiming the pointing device at the fixture when the fixture is not assigned to the group, and the user can remove a fixture from a group in the same way when the fixture was previously assigned to the group. This commissioning method can be used with a lighting system comprising a central control unit and a plurality of fixtures comprising luminaires, optional control devices, and optional standalone sensors, wherein each fixture includes a co-located sensor capable of receiving the signal emitted by the pointing device, and a central control unit which can communicate bidirectionally with each fixture. Additional user gestures are disclosed together with methods for the central control unit to acknowledge gestures. Additional communications methods among components of the lighting system are also disclosed.

### FIELD OF THE INVENTION

One or more embodiments of the present invention relate to lighting systems and methods for creating functional groups of fixtures in a lighting system.

### BACKGROUND

Lighting systems for areal illumination typically comprise (1) a set of “luminaires” (light fixtures comprising mounting hardware and one or more light-emitting elements such as incandescent or fluorescent bulbs or arrays of light-emitting diodes [LEDs]), together with (2) one or more sensor elements (motion sensors, light sensors, and the like), (3) control devices (such as dimmers and switches), and (4) power drivers to set the output light level of each luminaire as a function of sensor outputs and control device settings. Such systems can range in complexity from a single wall switch and bulb to commercial building lighting systems comprising hundreds of luminaires, sensors, and control devices.

A common way to specify, configure, and install such systems requires the use of discrete components, where each of the above elements are purchased separately, and the control logic is implemented by the way the components are connected together using wired or wireless connections. Where convenient, certain elements can be physically grouped. For example, an outdoor security light fixture can have a motion sensor built into the fixture, or a table lamp can have an on/off switch built in. Often, however, such combinations are not used, and each element is separately purchased, installed, and wired together in order to create functional groups.

As the total number of components increases, there can be a need for more sophisticated control systems. These are typically implemented using electronic control systems, which can be implemented using either custom electronics or software running on a more general-purpose control device such as a digital computer. Such systems require a trained engineer to manually connect all devices, describe the system to the control hardware and software, and to define the control functions to be implemented.

The cost of discrete components as well as the cost of installation and programming labor have thus far inhibited wide-spread adoption of sophisticated control systems. There are, nevertheless, obvious cost savings and performance benefits that can be realized by intelligently managing the on-time and on-intensity of each light source within lighting systems. Potential saving in electricity usage can be large, and safety and security can be enhanced. Nevertheless, to be widely adopted, the components need to be inexpensive, the installation should be quick and easy, and all configuration work should be possible within the skill range of an average commercial electrician or that of building maintenance personnel.

In order to reduce installation and commissioning costs as well as the skill level required to implement these tasks, it is possible to automate some of the commissioning steps. For example, co-owned and co-pending U.S. patent application Ser. No. 12/538,806 which is incorporated herein by reference, discloses methods for auto-commissioning a lighting system by using signal sources and sensors built into each fixture to automatically determine proximity of fixtures to each other and to automatically create logical groups. However, whether or not such auto-commissioning is used, in many cases, further refinements must be manually implemented. In the past, at least two people with cell phones or walkie-talkies coordinated the commissioning of fixtures with control systems to create or modify groups. One operated a control station and the other reported where they are in the building and observed lighting behavior to determine which lights are controlled by what logical entity in the control system's user interface.

Handheld programming devices have also been used to aid in programming the operations of lighting systems. For example, Cash, et al. (U.S. Patent Application Publication No. 2006/0202851) discloses the use of a handheld device to program various configuration parameters for a fluorescent lighting system. The device communicates via an infrared link to a receiver located on a lighting “bus” to which several programmable ballasts for driving fluorescent tubes are also attached.

### SUMMARY OF THE INVENTION

A method of commissioning a lighting system is disclosed. A user is provided with a pointing device capable of emitting or returning a signal which can be received by detectors co-located with each fixture in the lighting system. The user can add a fixture to a group by aiming the pointing device at the fixture when the fixture is not assigned to the group, and the user can remove a fixture from a group in the same way when the fixture was previously assigned to the group. This commissioning method can be used with a lighting system comprising a central control unit and a plurality of fixtures comprising luminaires, optional control devices, and optional standalone sensors, wherein each fixture includes a co-located sensor capable of receiving the signal emitted by the pointing device, and a central control unit which can communicate bidirectionally with each fixture. Additional user gestures are disclosed together with methods for the central control unit to acknowledge gestures. Additional communications methods among components of the lighting system are also disclosed.

### BRIEF DESCRIPTION OF THE DRAWINGS

FIG. 1 shows an example configuration of fixtures and a remote driver according to one embodiment of the present invention.

### DETAILED DESCRIPTION

Before the present invention is described in detail, it is to be understood that unless otherwise indicated this invention is not limited to specific construction materials, electronic components, or the like, as such may vary. It is also to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference to “a fixture” includes two or more fixtures; reference to “a sensor” includes two or more sensors, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Embodiments of the present invention can be used with various supersets and subsets of the exemplary components described herein. For concreteness, embodiments of the invention will be described in the context of a commercial building illumination system comprising a set of LED luminaires, but the invention is not limited to the use of LEDs as light sources nor to use in illuminating buildings.

Generally, a “lighting system” according to one or more embodiments of the present invention comprises a set of “fixtures,” and at least one central control unit which collects information of sensors and controls and determines the output light level for each light source which may vary from zero to maximum (a non-zero light level that is limited by a maximum sustainable operating point for the light source). Certain embodiments, such as those using fluorescent light sources, generally use local “ballasts” that each individually provide power control for one light source, and the central control unit provides a signal to instruct each local ballast to set a particular light level. In other embodiments such as those using LED luminaires, the central control unit can also function as a remote driver to provide the power for each luminaire. As used herein, a “fixture” can be a luminaires, or a standalone control or sensor; a “luminaire” is a light fixture including a light source plus suitable mounting hardware and decorative trim. In particular embodiments of the present invention, luminaires can further include light sensors designed to sense light from the light sources of adjacent luminaires (either via direct transmission or via reflection from the area under illumination) and additional signal sources and matching sensors using other wavelengths of light or other signal source/sensor technologies.

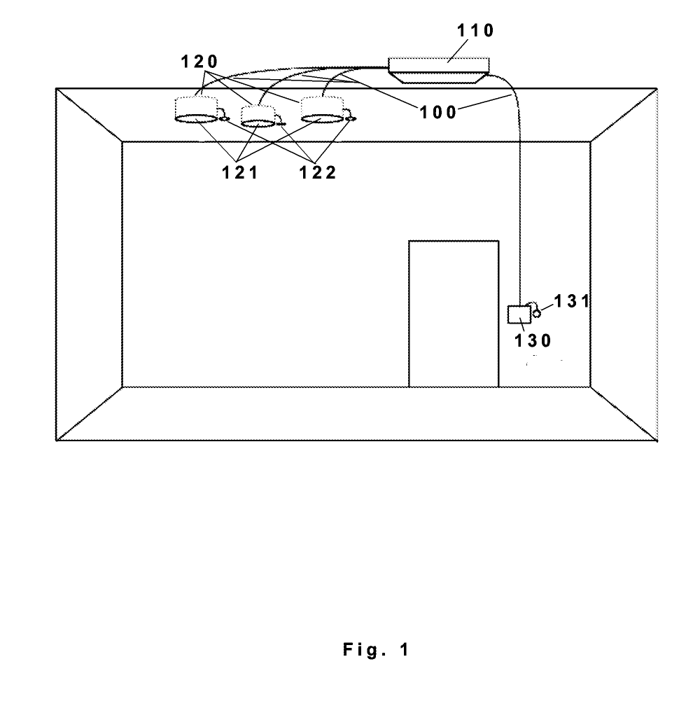

In accordance with embodiments using a remote driver, the lighting system further comprises communications means to allow each fixture to communicate with the remote driver. Such means can include direct wired connections, or any other known communications means such as optical fibers, wireless (radio frequency), ultrasonic, infrared, etc. An example system is illustrated in FIG. 1. A single room is shown. All fixtures are connected by wires 100 to remote driver 110 which is shown located above the ceiling, but can also be located in any other convenient utility location such as a closet or utility shaft, and can be located outside the room. Three luminaires 120 are shown each comprising a light source 121 and light sensors 122. The example system further comprises a wall controller 130 (a dimmer or switch) co-located with an additional light sensor 131.

In accordance with one or more embodiments of the present invention, each luminaire is co-located with at least one sensor and one signal source. The luminaire's light source (for example, a set of LEDs capable of emitting visible white light or a facsimile thereof) can serve as the signal source. As used herein, the term “light source” is to be construed narrowly to encompass sources emitting predominantly visible light unless specifically identified otherwise (as, for example, “infrared light source”). The term “radio frequency” is to be construed herein to describe electromagnetic waves from about 100 kHz to 10 GHz. Such waves do not include infrared, visible, or ultraviolet light.

In certain embodiments, additional signal sources using various technologies such as radio frequency antennas; infrared, ultraviolet, or visible light sources; or ultrasonic emitters can also be provided. Such additional signal sources can provide means for measuring a variety of quantities useful for providing input to a remote driver for a lighting system. Such quantities include motion, daylight, equipment-on status, presence of people, sound and noise, and the like. Sensors capable of receiving signals from the signal source(s) are also provided. For example, if the luminaire light source is the sole signal source provided, then an optical sensor such as a photodiode, phototransistor, or photoresistor built into the luminaire can be used as a suitable sensor. As another example, if an ultrasonic emitter is built into each luminaire or other fixture, then an ultrasonic detector can be built into each fixture to receive and detect the ultrasonic signals emitted by the emitter co-located in the same fixture as the detector as well as those co-located with other fixtures. Further, each luminaire is associated with a microcontroller which serves as a luminaire controller. The microcontroller is capable of transmitting the output of sensors to the remote driver. In certain embodiments, the microcontroller is also capable of controlling one or more of the installed signal sources, although typically it is not capable of directly controlling the power to the luminaire's main light source which is controlled instead by the remote driver. Microcontrollers can be dedicated to single luminaires or shared among two or more fixtures.

In accordance with one or more embodiments of the present invention, “groups” of fixtures are created to define sets of fixtures that should work together logically. For example, all of the luminaires, controls (such as switches and dimmers), and sensors (such as motion sensors and daylight sensors) associated with a particular room can be assigned to a single group. Fixtures associated with other rooms can be assigned to other groups so that each group corresponds to a room, hallway, or portion thereof, according to the illumination needs of the various spaces in the system. Such groups can be created automatically using the auto-commissioning methods of co-owned and co-pending U.S. patent application Ser. No. 12/538,806. Whether or not auto-commissioning is used, there can be a need to make manual assignments to groups.

In accordance with one or more embodiments of the present invention, the remote driver can be placed into a special commissioning mode. The special commissioning mode can be entered via a user interface. A user can then view groups already created by auto-commissioning, create or edit names assigned to such groups (e.g., “Conference Room 1,” “Break Room,” “Second Floor Hallway,” “Bob's Office,” etc.), delete groups, and create new groups (initially without any assigned fixtures). Once a set of such groups has been created, the user can leave the remote driver and perform group assignments on-site at each group location. Additionally, new groups can be created on-site as described below.

If the user has no immediate need to enter any new information directly into the remote driver, then the special commissioning mode can be entered through any suitable interface available in the system. Examples of alternative means of entering the special commissioning mode include “gestures” made with pointing devices (see below), controls such as switches and dimmers, and sensors such as motion and presence sensors. Gestures can be created that are distinct from those that would occur in normal use of the lighting system. For example, a wall switch could be used with a gesture comprising three or more rapid flashes that would thereby be distinct from normal on-off lighting control. Pointing devices may or may not require special gestures to enter the special commissioning mode. If a pointing device always generates a unique signal (as for some embodiments of the intelligent pointing devices described below), then no special gesture is required. On the other hand, to use a simple flashlight pointing device, a special gesture can be useful to distinguish from random flashes of light. Such a special gesture can be created manually using any detectable pattern that is unlikely to occur by accident. For example, the user could point successively to the four corner fixtures already part of an existing group, or the user could point four times in close succession to an unassigned fixture. It is also possible to use a code card having slots in an opaque material or dark patches on a transparent material. Such a code card can be dragged in front of a flashlight or laser pointer to generate a unique code.

In accordance with one or more embodiments of the present invention, the system can be secured against unauthorized entry into the special commissioning mode by requiring an administrative code or password for access. Such passwords can be transmitted encoded in gestures as described above. Special wall controllers with keypads can also be provided to enable authorized users to dial the administrative access code or password.

In accordance with one or more embodiments of the present invention, the user is provided with a handheld “pointing device” capable of pointing to fixtures in a way that can be detected by the sensor co-located with each fixture. Any signal source technology which is compatible with sensors built into all fixtures can be used. Non-contact devices, such as infrared or visible light flashlights and laser pointers, ultrasonic or acoustic emitters, short-range radio wave devices such as those using bluetooth and radio-frequency identification (RFID) technology, chemical sensors, etc., which are sufficiently directional or short-range to be able to single out individual fixtures, can be used, as long as each fixture has a sensor capable of detecting the signal. Contact devices can also be used, provided that each fixture has a sensor capable of detecting contact such as, for example, a capacitive or pressure sensitive touch sensor. Where compatible signal emitters and detectors are both present in all fixtures, then reflective or retro-reflective or even non-reflective objects can be used as pointing devices. Any object that can significantly change the amount of reflected signal returned to a detector in a fixture from its co-located signal emitter can be used as a pointing device, as long as the resulting detected signal change can readily be distinguished from the “noise” of other activities and signal sources such as the movement of the user and stray light sources.

In accordance with one or more embodiments of the present invention, the user points the handheld device at one fixture at a time and waits for the control unit to acknowledge the signal received. For example, the control unit can flash a light source (for example, a luminaire) as acknowledgement. In the context of acknowledgement, “flashing” one or more light sources can be performed either by toggling the appropriate light source(s) on then off (or off then on, if already on) for an interval ranging from a few milliseconds to a few seconds, or alternatively, the level of the appropriate light source(s) can be ramped up and down over similar time periods to provide a distinctive acknowledgement. A variety of user “gestures” and remote driver responses can be implemented to facilitate commissioning tasks.

In accordance with one or more embodiments of the present invention, a “dumb” pointing device is used. Such a device provides no means for encoding information other than the pointing action itself. For example, a flashlight pointing device can be used. Several gestures are possible in coordination with acknowledgement signals provided by the control unit. For example, a new group can be created by pointing sequentially to an unassigned fixture and then to all other fixtures that are to be members of the group. A fixture can be removed from the group by pointing to that fixture again. Group membership would thereby be toggled on and off by repeatedly pointing at a particular fixture. For fixtures (such as switches and dimmers) that do not have signal sources that can be used to acknowledge pointing, the remote driver can provide such acknowledgement by flashing all luminaires currently assigned to the group instead. For fixtures such as luminaires that can acknowledge pointing, the remote driver can provide both individual fixture acknowledgement by flashing the fixture, and group assignment by subsequently flashing the entire group. As an additional form of user feedback, the remote driver can also turn on all luminaires in a group as long as that group is being processed. In this case, any gesture requiring flashing of the entire group would momentarily turn off the member of the group. In order to move on to a new group, the user can either point to a fixture already assigned to a different group, or if an additional new group is to be created, a suitable waiting time can be used. For example, the remote driver can assume that any unassigned fixtures pointed to within intervals of less than a suitable predefined interval such as 30 seconds should be assigned to the current group. Pointing to an unassigned fixture after the predefined interval can be used as a gesture to indicate that a new group should be started. The predefined interval can be set to be significantly longer than the average time between the gestures used to add or remove fixtures from a group.

In accordance with one or more embodiments of the present invention, the user must provide a “confirmation” or “commit” signal before any change in group assignments is made. This additional step can be useful to reduce the possibility of accidental changes. After a user points to a fixture, the remote driver provides an acknowledgment signal indicating that a fixture has been chosen. The user then points to the fixture again within a suitable time interval to confirm the selection before action (adding or removing the fixture from a group) is taken.

It is possible that auto-commissioning has resulted in undesirable fixture assignments. For example, the user may wish to move the boundary between two adjacent groups, because a new partition was installed after auto-commissioning. In such situations, the user may not be able to see all fixtures that were assigned to the current group by auto-commissioning, and thus would not know of or be able to see all fixtures that need to be removed from the current group. However, when checking fixture assignments on the other side of the partition, the user would notice that the incorrectly assigned fixtures were not assigned to the expected group on that side. These fixtures could then be reassigned correctly merely by pointing at them with the pointing device. If desired, the remote driver can respond with a unique acknowledgement signal (a different flash pattern, for example) to indicate a reassignment rather than a first assignment for that fixture.

The remote driver can also signal to the user that the timeout has expired by providing a special acknowledgement signal such as a double flash. To resume making assignments to an existing group after the timeout (or at the beginning of a commissioning session), the user can point to any member of the group. The remote driver would acknowledge by flashing or increasing the light level of the entire group, initially without removing any fixture from the group. Alternatively, instead of waiting for the timeout period to expire to provide the special acknowledgement signal, the lights could switch from on (indicating that a group is being processed) to flashing to indicate that the timeout period will expire in a few seconds if no further action is taken. When the timeout period expires in this example, the lights would turn off or to a low level to indicate that processing of the group is no longer active.

New groups created on-site using a dumb pointing device would be unnamed, or they could have default names such as “Flashlight Group 1” and could have additional flags set to indicate that they were created using manual commissioning. The user can note each new group so created on paper or other portable device such as a personal digital assistant (PDA) or laptop computer. When he returns to the user interface at the remote driver, he can be presented with a list of newly created groups in the order in which they were created, and names can then be assigned or edited according to the user's notes.

In accordance with one or more embodiments of the present invention, additional information can be sent to the remote driver by using an “intelligent” handheld/portable pointing device. Intelligent pointing devices are capable of transmitting short codes which can increase the repertoire of gestures that are available. Custom intelligent pointing devices can be built, but it is also possible to create intelligent pointing devices by using software running on general purpose handheld computing devices such as PDAs, cell phones with computing capabilities, or laptop computers. In certain embodiments a signal emitter is added as an attachment to an I/O port; in other embodiments existing built-in signal sources can be used. Examples of built-in signal sources include display screens, infrared communications links, and the LED in an optical mouse. Intelligent pointing devices can provide either one-way or two-way communications as described below.

An intelligent pointing device can allow a user to create, name, and select groups. When a particular group is selected, a unique identifying code can be repeatedly transmitted, for example, by low-frequency modulation of light emission. In accordance with one or more embodiments of the present invention, one-way communication between the intelligent pointing device and fixtures is provided, wherein the intelligent pointing device emits a code which can be detected by the sensors co-located with each fixture. The remote driver detects the code received at a particular fixture and respond by assigning that fixture to the group associated with that code or removing that fixture from the group associated with that code. Acknowledgement signals can be provided similar to those used with dumb pointing devices, although no timeout would be needed for identification of new groups. Instead, the user can select a new group on the intelligent pointing device, and subsequent adding and removing gestures would apply to the new group.

In accordance with one or more embodiments of the present invention, if the pointing device allows the user to enter names for groups, then these names can be uploaded to the controller via a separate gesture, either directly to the control unit or indirectly via any fixture. Uploads from the intelligent pointing device can be made using any available communications technology. Examples include wireless networking (“WIFI”), USB wired links, infrared wireless links, cellular telephone data links in addition to communication via the sensors built-in to fixtures. Some of these communications modes allow pointing devices to be always “on-line” (i.e., connected to the remote driver); others require that the pointing device be later connected to the remote driver for data upload (i.e., some fixture commissioning functions such as group naming could be performed “off-line,” and the data could be uploaded later to the remote driver).

In accordance with one or more embodiments of the present invention, controls and/or sensors present in the system can be used to indicate that a different group is being processed. For example, when a motion sensor associated with a different group detects that the user has moved to a new area, the fixtures assigned to that group are flashed as an acknowledgement, and the user can begin adding or removing fixtures from that different group. Similarly, the user can toggle a switch or adjust a dimmer control that is not assigned to the current group to indicate that he now wishes to process a different group. Toggling a switch or adjusting a dimmer control that is already a member of the current group can also be used as a gesture to indicate that the user is finished processing that group.

In accordance with one or more embodiments of the present invention, an intelligent pointing device can also be equipped to provide two-way communication with fixtures. Any suitable communications method or methods can be used. For example optical links can be used. The use of an optical signal source in the pointing device has been described above. The intelligent pointing device can also be provided with an optical sensor. A simple photoresistor, photodiode, or phototransistor can be used, or if the pointing device has a built-in camera (as, for example, a cell phone), the camera can be used as the optical sensor.

To use two-way communication, after auto-commissioning, the system can be placed into the special commissioning mode. The fixtures associated with each group in the system can be set to emit unique codes that can be detected by the intelligent pointing device. For example, the codes can be emitted as low-frequency amplitude modulation of the luminaire light sources. Any suitable modulation can be used. A preferred embodiment uses a modulation which can be easily detected by the intelligent pointing device but is not annoying to persons in the area. For example, a modulation between two non-zero light levels at about 20-30 Hz can be used—slow enough so that a video camera can be used to detect the modulation but at levels that are not annoying to persons in the area. Higher frequency modulation can be used with intelligent pointing devices that include optical sensors other than video cameras.

The intelligent pointing device can detect the code to determine which group is to be processed, and the user can proceed to add or remove fixtures from the group. The user can also name the group or match the group to a predefined name from a location list which could, for example, have been defined from a floor plan of the system.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practiced without these specific details. In other instances, well known methods, procedures, and components have not been described in detail so as not to unnecessarily obscure aspects of the present embodiments.

What is claimed is:

1. A method of commissioning a lighting system comprising
providing a user with a pointing device capable of emitting or returning a signal which can be received by sensors co-located with each fixture in said lighting system,
adding a fixture to a group if said user aims said pointing device at said fixture and said fixture is not assigned to said group, and
removing a fixture from a group if said user aims said pointing device at said fixture and said fixture was previously assigned to said group;
wherein said lighting system comprises a plurality of fixtures comprising luminaires, optional control devices, optional standalone sensors and a central control unit which can communicate bidirectionally with each fixture.

2. The method of claim 1 wherein said central control unit further comprises a remote driver which can receive data from said co-located sensors and set output levels for luminaires or auxiliary signal emitters.

3. The method of claim 1, wherein said pointing device is located at least 3 feet from said fixture toward which said user aims said pointing device.

4. The method of claim 1, wherein said pointing device is in contact with or in close proximity to said fixture toward which said user aims said pointing device.

5. The method of claim 1, wherein the signal emitted or returned by said pointing device comprises a constant level.

6. The method of claim 1, wherein said the signal emitted or returned by said pointing device comprises embedded data.

7. The method of claim 6, wherein said data comprise an identifying code for said group.

8. The method of claim 7, wherein said user can create, delete, name, and rename groups via a user interface on said pointing device, and wherein said user can select via said user interface a group for use in said adding and removing steps.

9. The method of claim 1, wherein said pointing device further comprises a sensor capable of receiving signals emitted by said plurality of fixtures.

10. The method of claim 9, wherein said central control unit encodes the identity of each group in a signal emitted by all fixtures which are capable of emitting a signal and assigned to said group.

11. The method of claim 1, wherein said central control unit generates an acknowledgement signal to the user via the fixture being added or removed.

12. The method of claim 1, wherein said central control unit generates an acknowledgement signal to the user via all fixtures capable of emitting a signal and assigned to said group.

13. The method of claim 1, wherein said central control unit causes all fixtures which are capable of emitting a signal and assigned to said group to emit a signal to indicate current members of said group.

14. The method of claim 13, wherein said signal to indicate current members of said group comprises setting all luminaires in the group to a fixed level.

15. The method of claim 13, wherein said signal to indicate current members of said group comprises causing all luminaires in the group to flash.

16. The method of claim 13, where said signal to indicate current members of said group comprises causing all fixtures which are capable of emitting a signal and assigned to said group to emit a signal which encodes the identity of said group.

17. The method of claim 1, wherein said user can indicate that a different group is to be processed by aiming said pointing device at a fixture not a member of the group last processed after at least a predefined interval set to be significantly longer than the average time interval between said adding or removing steps.

18. The method of claim 17, wherein said central control unit causes all fixtures which are capable of emitting a signal and assigned to said group to emit a signal to indicate expiration of said predefined interval.

19. The method of claim 17, wherein said central control unit causes all fixtures which are capable of emitting a signal and assigned to said group to emit a signal to indicate that said predefined interval will expire in a few seconds.

20. The method of claim 1, wherein the identity of the group to be processed is changed when motion or presence is detected at a motion or presence sensor not a member of the group last processed.

21. The method of claim 1, wherein the identity of group to be processed is changed when said user toggles a control switch or adjusts a dimmer control not a member of the group last processed.
